(19) United States
(12) Patent Application Publication
(10) Pub. No.: US 2020/0151748 A1
(43) Pub. Date: May 14, 2020

(54) FEATURE-BASED ITEM SIMILARITY AND FORECASTING SYSTEM

(71) Applicant: Walmart Apollo, LLC, Bentonville, AR (US)

(72) Inventors: Suprit SAHA, Bengaluru (IN); Anindya Sankar DEY, Bangalore (IN); Chandan KUMAR, Bengaluru (IN); Eshan JAIN, Bengaluru (IN)

(73) Assignee: Walmart Apollo, LLC, Bentonville, AR (US)

(21) Appl. No.: 16/682,823

(22) Filed: Nov. 13, 2019

Related U.S. Application Data
(60) Provisional application No. 62/823,268, filed on Mar. 25, 2019.

(30) Foreign Application Priority Data
Nov. 14, 2018 (IN) 201821042808

(51) Int. Cl. G06Q 30/02; G06F 16/2458; G06F 16/28; G06N 7/00; G06N 20/00

(52) U.S. Cl. CPC G06Q 30/0206; G06F 16/2474; G06N 20/00; G06N 7/005; G06F 16/285

(57) ABSTRACT

A feature-based item similarity and forecasting system is provided. An exemplary item forecasting system can include: a processor; and a computer-readable non-transitory storage medium memory storing computer executable instructions, the instructions operable to cause the processor to execute: a shape characteristics based classification module programmed to: acquire a plurality of time series datasets, generate a plurality of first datasets comprising shape and effect features, and generate a plurality of second datasets with shape labels, wherein the items in the second datasets are classified into clusters and wherein each cluster shares a shape label; and a forecasting module programmed to: run a plurality of candidate forecasting models on each shape label, select a best forecasting model with a lowest average forecast error for each shape label, and assign the best forecasting model to each item in the cluster sharing the shape label for an item prediction.

### CROSS-REFERENCE TO RELATED APPLICATIONS

This patent application claims the priority to Indian Provisional Application No. 201821042808, filed Nov. 14, 2018, and U.S. Provisional Application No. 62/823,268, filed, Mar. 25, 2019, contents of which are incorporated by reference herein.

### BACKGROUND

### 1. Technical Field

The present disclosure relates to inventory control, and more specifically to systems and methods for forecasting item demand and identifying item similarity.

### 2. Introduction

A merchandise retailer may provide millions of items to customers through a chain of retail stores. Two of the most common problems in retail management may be related to understanding item-item similarity relationships and accurately forecasting item demand. To timely fulfil the item demand of each store, it is important to precisely forecast a number of items for each store-item combination to minimize overstocking and avoid out-of-stock situations. It is also very important to understand similarity relationships between different items. The similarity between different items may be used to estimate sales patterns of newly introduced items, market cannibalization effect, product grouping, etc. Current systems generally utilize physical attributes of items to estimate item similarity. However, the computer cannot recognize or process time series variables, and also cannot recognize or process a shape of a graph of time series variables.

### SUMMARY

An exemplary forecasting system according to the concepts and principles disclosed herein can include: a processor on a computing device; and a computer-readable non-transitory storage medium memory storing computer executable instructions, the instructions operable to cause the processor to execute: a shape characteristics based classification module programmed to: acquire a plurality of time series datasets associated with a plurality of items, generate, based on date labels associated with the plurality of time series datasets, a plurality of first datasets comprising shape-based features and effect-based features, and generate, based on the plurality of the first datasets, a plurality of second datasets with shape labels, wherein the items in the second datasets are classified into clusters and wherein each cluster shares a shape label; and a forecasting module programmed to: run a plurality of candidate forecasting models on each shape label associated with each cluster in the second datasets to obtain an average forecast error for each shape label, select a best forecasting model with a lowest average forecast error for each shape label, and assign the best forecasting model to each item in the cluster sharing the shape label for an item prediction.

Another exemplary system for identifying item similarity according to the concepts and principles disclosed herein can include: a processor on a computing device; and a computer-readable non-transitory storage medium memory storing computer executable instructions, the instructions operable to cause the processor to execute: a shape characteristics based classification module programmed to: acquire, from the database, a plurality of time series datasets associated with a plurality of items, generate, based on date labels in plurality of time series datasets, a plurality of first datasets comprising shape-based features and effect-based features, and generate, based on the plurality of first datasets, a plurality of second datasets with shape labels, wherein the items in the second datasets are classified into clusters and wherein each cluster shares a shape label; and an item similarity module programmed to: select a reference item for each cluster of items, apply a plurality of search models respectively on shape-based and effect-based features of the reference item in the second datasets to obtain a plurality of similarity values, the plurality of search models comprising a full feature search, a reduced feature search, a model based search, and a fast combined search, and identify top K similar items for the reference item with a decreasing order of the plurality of the similarity values.

A non-transitory computer-readable storage medium having executed instructions stored which, when executed by a processor, cause the processor to perform operations comprising: acquiring, from a database, a plurality of time series datasets; generating, based on date labels associated with plurality of time series datasets, a plurality of first datasets comprising shape-based features and effect-based features; and generating, based on the plurality of the first datasets, a plurality of second datasets with shape labels, wherein the plurality of second datasets are classified into clusters and wherein each cluster shares a shape label, wherein generating the plurality of the second datasets comprising: randomly sampling the first datasets to generate training data and test data; performing a multi-stage clustering on the training data to initially identify and assign shape labels to the training data; calculate, by a machine learning classification model, probabilities of each of shape labels for each time series of test data to predict and assign a shape label with a highest probability to a time series of training data; train the machine learning classification model with the plurality of shape labels as responsive variables and shape-based features and effect-based features from the first datasets as independent variables; and score the test data with the machine learning classification model to assign a shape label to the test data to generate the second datasets with the shape labels.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Example embodiments of this disclosure are illustrated by way of an example and not limited in the figures of the accompanying drawings, in which like references indicate similar elements and in which:

FIG. 1 is a block diagram illustrating an example computing environment in accordance in accordance with some embodiments;

FIG. 2 is a system workflow diagram illustrating a methodology for forecasting item demand and identifying item similarity in accordance with some embodiments;

FIG. 3 is a diagram illustrating identified similar items in accordance with some embodiments;

FIG. 4 is a flowchart diagram illustrating an example process for implementing a shape characteristics based classification in accordance with some embodiments;

FIGS. 5A, 5B, and 5C are diagrams illustrating examples of a cluster of items with time series sharing a shape label with a curve shape in accordance with one embodiment;

FIGS. 6A, 6B, and 6C are diagrams illustrating examples of a cluster of new items with time series sharing a shape label in accordance with one embodiment;

FIGS. 7A, 7B, and 7C are diagrams illustrating examples of a cluster of items with time series sharing a shape label with a spike shape in accordance with one embodiment;

FIGS. 8A, 8B, and 8C are diagrams illustrating examples of a cluster of items with time series sharing a shape label with a scattered shape in accordance with one embodiment;

FIGS. 9A, 9B, and 9C are diagrams illustrating examples of a cluster of items with time series sharing a shape label with a steady changing shape in accordance with one embodiment; and

FIG. 10 is a block diagram of an example computer system in which some example embodiments may be implemented.

It is to be understood that both the foregoing general description and the following detailed description are example and explanatory and are intended to provide further explanations of the invention as claimed only and are, therefore, not intended to necessarily limit the scope of the disclosure.

### DETAILED DESCRIPTION

Various example embodiments of the present disclosure will be described in detail below with reference to the accompanying drawings. Throughout the specification, like reference numerals denote like elements having the same or similar functions. While specific implementations and example embodiments are described, it should be understood that this is done for illustration purposes only. Other components and configurations may be used without parting from the spirit and scope of the disclosure, and can be implemented in combinations of the variations provided. These variations shall be described herein as the various embodiments are set forth.

The concepts disclosed herein are directed to systems and methods of forecasting item demand and identifying item similarity based on the underlying shape-based and effect-based features of a time serial historical data.

As will be described in greater detail below, embodiments of the invention can identify item attributes associated with temporal variables of certain time serial historical data. The system can capture the comprehensive shape characteristics and effects of the time series historical data. Embodiments of the invention are described below in the context of processing time series data and shape recognition regarding sales of an item. However, embodiments of the invention may also be applied to different types of time series data. These features are useful in identifying optimal time series models leading to improved item forecasting performance. In some embodiments, the system can provide a most appropriate forecasting model for each item and each of the pattern-based segments. In some embodiments, the system may efficiently recommend a group of top-K similar items for a particular item.

Additionally, the system may correctly identify different sales patterns associated with various given store-item combination across years, which can lead to an accurate item prediction by forecasting of item demand and sales trend, and a better understanding of similar items. The proposed system can be deployed at a retailer scale using distributed computing.

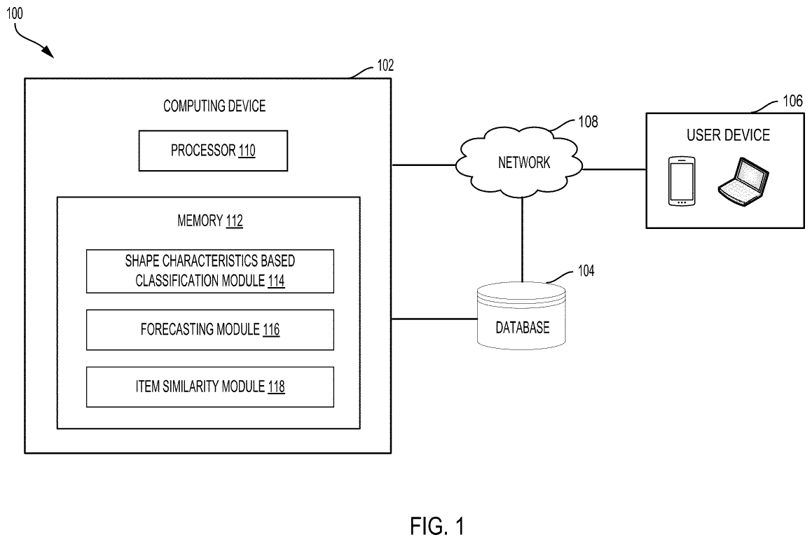

FIG. 1 is a block diagram illustrating an example computing system 100 in accordance with some embodiments. The example computing system 100 generally includes a computing device 102, a database 104, a user device 106 and network 108.

The computing device 102 may include a processor 110 and a memory 112. The memory 112 may store various modules or executed instructions/applications to be executed by the processor 110. The computing device 102 includes different functional or program modules which may be software modules or executive applications stored in the memory 112 and executed by the processor 110. The program modules include routines, programs, objects, components, and data structures that can perform particular tasks or implement particular data types.

In some embodiments, the computing device 102 may include one or more processors to execute the various functional modules including a shape characteristics based classification (SCBC) module 114, a forecasting module 116, and an item similarity module 118.

In some embodiments, the example computing system 100 may include a plurality of computing devices. The various functional modules may be included in different computing devices to fulfill particular functions. For example, the forecasting module 116 may be implemented in a computing device. The item similarity module 118 may be implemented in different computing devices.

The example computing system 100 may maintain a database 104 to store a variety of different types of data or a computer program product. The data may be organized in a variety of different ways and from a variety of different sources. The computer program product may include code or machine-executable instructions that may represent a procedure, a function, a subprogram, a program, a routine, a subroutine, a module, a software package, or any combination of instructions, data structures, or program statements. The computing device 102 can communicate with the database 104 to execute one or more sets of processes. The database 104 may be communicatively coupled to the computing device 102 to receive data from or send data to the computing device 102 via the network 108. In some embodiments, the database 104 may store all time serial historical data including sales, price, holiday data and marketing promotions data associated with all items in retail stores during a period of time (e.g., a day/week/month/year).

The user device 106 may represent at least one of a portable device, a tablet computer, a notebook computer, or a desktop computer that allows users to communicate with the computing device 102 to perform related online activities via the network 108.

The network 108 may be a terrestrial wireless network, Wi-Fi, and other type of wired or wireless networks. The network 108 can also be implemented using any type of network topology and/or communication protocol, and can be represented or otherwise implemented as a combination of two or more networks.

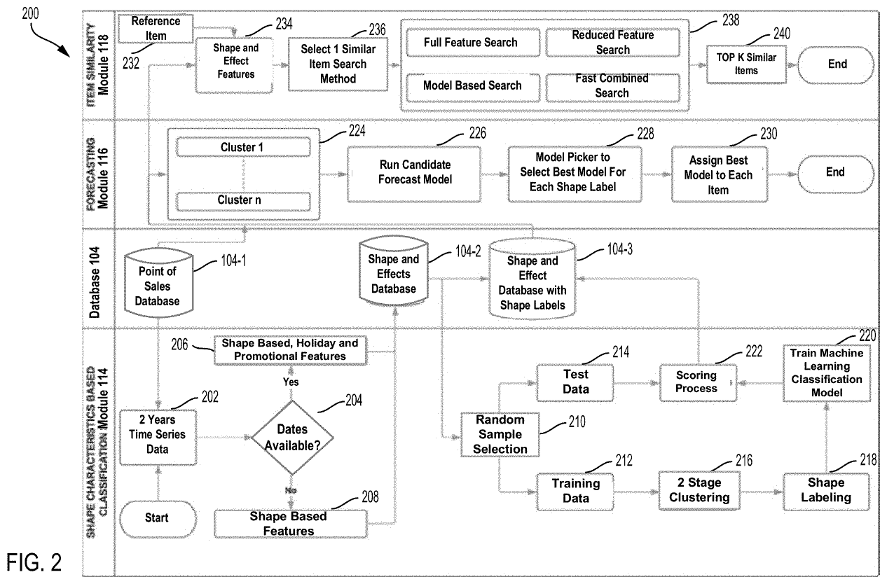

FIG. 2 is a system workflow diagram illustrating a methodology for forecasting item demand and identifying item similarity in accordance with some embodiments.

As illustrated in FIG. 2, the system workflow 200 may be associated with processes executed by the shape characteristics based classification (SCBC) module 114, the forecasting module 116, and the item similarity module 118. The system may utilize at least two year time series historical dataset as the primary input.

The time series historical dataset can be obtained by Point-of-Sale (POS) devices of a retailer and stored in a POS database 104-1. The time series datasets include historical sales, price, holiday data and marketing promotions data for all items over a period of time. The time series historical datasets may be represented as a matrix. Each time series dataset in the time series datasets may be associated with a particular item. Each time series dataset for a particular item may be a sequence of data of temporal variables of interest at a given time interval (e.g., week/month/year). The temporal variables of interest for each item may include price, sales, date label (e.g., sales date), holiday data, marketing promotion data, and any other type of temporal variable of interest associated with the item. In some embodiments, the shape-based features of an item are associated with temporal variables, such as sales and price, etc. The effect-based features of the item are associated with temporal variables, such as holiday data and marketing promotion data. The system may automatically quantify item temporal characteristics including shape-based and effect-based features.

The shape characteristics based classification (SCBC) module

Referring to FIG. 2, the system workflow 200 may include a process executed by the SCBC module 114 to create the time series datasets with shape-based and effect-based features for a plurality of items. The SCBC module 114 can be configured to extract multiple shape-based and effect-based features from the time series datasets to capture shape features as well as effect features of holidays and promotions for each item. In some embodiments, the system may take at least two-year time series historical data as the primary input. The SCBC module 114 may be configured to automatically process the time series datasets of a plurality of items and to generate a plurality of shape and effect datasets (e.g., first datasets) with shape features and effect features.

Based on the first datasets with shape features and effect features for all items, the SCBC module 114 can generate the updated shape and effect database 104-3 for storing second datasets with shape labels for all items.

At 202, the SCBC module 114 can acquire at least two-year time series historical datasets associated with a plurality of items from the point of sale (POS) database 104-1.

At 204, the SCBC module 114 may determine whether a date label is present in the time series dataset of the item. The date label may be a data label associated with a sale date of the item and stored in the time series dataset associated with the item.

At 206, if the SCBC module 114 determines that the date label is present in the series historical dataset, the SCBC module may be configured to create effect-based features associated with holiday and promotion data and shape-based features from the time series datasets. The associated holiday and promotion features in a given week in a particular year can be mapped to the corresponding time serial dataset. The SCBC module 114 may generate an initial shape and effect dataset (e.g., a first shape and effect dataset) for each item.

At 208, if the SCBC module 114 determines that a date label is not present in a time series dataset of the item, the SCBC module 114 may only generate a first shape and effect dataset with extracted shape-based features associated with the item. As such, the first datasets can include shape-based features and effect-based features extracted from the time series dataset with various temporal variables of interest for each item.

The system can algorithmically segment a time series dataset for each item based on the underlying shapes of certain temporal variable of interest. The SCBC module 114 can automatically quantify items temporal characteristics based on its shape of a temporal variable of interest in segments over a given time period (e.g., one week/month/year). In addition to shape-based features, different effects of holidays and promotions have been statistically developed to capture the comprehensive characteristics of each item. Variety of search techniques may be developed and utilized to rank similar items based on the above features.

For example, the shape-based features may be created for each item based on the time series historical data. The shape-based features for each item may be extracted as various features, such as autocorrelation, Kurtosis, trend, non-linear, Hurst, Lyapunov, and skewness, etc. Effect-based features may be created by regressing holiday and promotion variables on sales for each item. Standardized coefficients may be calculated to estimate the relative impact of holidays and promotions variables associated with item sales.

Based on the primary input data, the SCBC module 114 may create a first shape and effect datasets including multiple features for all items to capture shape characteristics of time series as well as effect characteristics of holidays and promotions data for each item. The SCBC module 114 may create the first shape and effect dataset by collating shape features and effects features for each item. The created first datasets may be stored in a shape and effect database 104-2. In some embodiments, the shape and effect database 104-2 may store the created shape and effect datasets for millions of items.

In some embodiments, the objective of the SCBC module 114 can be configured to assign and add the shape label to the first dataset associated with each item. Each type of shape label may identify a particular shape shared by a group or cluster of similar items.

By referring to FIG. 2, the methodology for assigning a shape label to each item is illustrated in the operations of 210-222 in the system workflow 200. The first shape and effect feature datasets stored in the first shape and effect database 104-2 may include millions of items. Based on the first shape and effect datasets, the SCBC module 114 may utilize a two stage clustering methodology and a machine learning (ML) model to identify the similar items. The SCBC module 114 may assign the same shape label to each cluster of the similar items. Shape labels are identified with statistics measures created from the raw time serial historical data. The system may use a multi-stage clustering algorithm to initially assign a shape label on a randomly sampled training data. Further, a machine learning classification model is trained on this augmented training data where the identified shape label is the response variable (e.g., target variable) and the features from the first shape and effect database are independent variables (e.g., covariates). The training data 212 may be represented as a plurality of training datasets used for clustering.

The SCBC module 114 may use the machine learning classification model for scoring remaining items (test data) to predict and assign the shape labels for all items in the first shape and effect datasets.

Random Sample Selection

Two Stage Clustering Methodology

At 210, the samples of the first datasets can be randomly sampled and selected to be training data 212 and test data 214. The training data is used for label clustering first.

At 216, the system may utilize a multi-stage clustering algorithm to process the first datasets and assign a shape label to each item in the first shape and effect based dataset. In the first stage of clustering, clustering is applied on repeated bootstrapped samples drawn from the training data. Bootstrapping is a type of resampling where large numbers of smaller samples of the same size are repeatedly drawn with replacement from a single original sample. Bootstrapping relies on random sampling with replacement.

Optimal number of clusters may be decided for different items by using elbow plot. Every drawn sample cluster numbers are stored for each item.

In the second stage of clustering, the items consistently remaining in a same cluster are identified. The objective of this stage is to identify items to form a homogeneous cluster and the remaining ambiguous items may be moved to be test data. As such, the items with inconsistent cluster labels may be removed from the training dataset.

At 218, based on the clustering results, the final clusters may be formed and represented with key characteristics of items, such as curve, peak, first of month, intermittent, etc. The key characteristics of items may be defined with or represented by various types of shape labels and stored in a file. A particular shape of a segment of the time series dataset may be represented by a shape label shared by a cluster of items. The training datasets may be filtered and assigned with a particular shape label (e.g., cluster label) based on the key characteristics of items. For example, various types of shape labels may be represented as a series of numbers, such as 0, 1, 2, and 3.

Machine Learning Classification Model

A machine learning classification model is developed and trained on this augmented training data where the identified shape label is the response variable and features from the shape and effect datasets are independent variables.

At 220, a machine learning classification model may be used and built to assign the shape label to the test data. This machine learning classification model is used to classify the first datasets into identified clusters. The shape labels identified in the filtered training datasets are used as response variables. All features from the initial shape and effect datasets are considered as independent variables.

Scoring Process

At 222, a scoring process may be conducted by applying the shape labels to all items in test data 214. The output of the scoring process may be a second shape and effect datasets with shape labels for the plurality of the items. All items in the test data 214 may not involve in the clustering process.

In some embodiments, the machine learning classification model is applied on the test data 214 for scoring the shape labels on all items in the first datasets to generate the second datasets for storing in the database 104-3. The foregoing descriptions of specific embodiments of the present invention has been presented for purposes of illustration and description.

Forecasting Module 116

By referring to FIG. 2, the methodology for assigning a best forecasting model to each item is illustrated in the operations of 224-230 in the system workflow 200.

Using the historical sales data from the POS database and the shape labels from the second datasets (the updated shape and effect database), the forecasting system may be configured to run forecasting models with different algorithms on each cluster, select a best forecasting model for each shape label, and assign the best forecasting model for each item in the cluster sharing the shape label.

The second datasets with shape labels stored in a second database 104-3 may be used as an input to the forecasting module 116 and the item similarity module 118, respectively.

The forecasting module 116 identifies the appropriate model for a particular shape label using historical sales data from the POS database 104-1 and shape labels from a second datasets. There are many forecasting algorithms or models in the market. Different forecasting models are generally suitable for different items with different shape labels. The system identifies the appropriate models based on the assigned cluster labels.

The forecasting module 116 may be configured to identify the best forecast model for each item with a particular shape label. This leads to a more efficient system which can unlock a higher level of accuracy with reduced run time.

At 224, shape labels may be obtained from the second datasets for clusters 1-n as illustrated in FIG. 2. At 226, the system may run a plurality of candidate forecasting models and obtain an average forecast error on each cluster in the second datasets.

At 228, the system can select a best forecasting model with a lowest average forecast error for a shape label of each cluster. The system may include a module of model picker for selecting the best forecasting model for each shape label.

At 230, the system may assign the best forecasting model to each item in the cluster sharing the shape label for an item prediction. The system can predict or forecast item sales trend and item demand in each cluster using the best forecasting model.

For example, the forecasting module 116 may run 5 different forecasting algorithms (e.g., forecasting models) F₁, F₂, F₃, F₄, and F₅ on shape labels. The forecasting module 116 may be used to implement the following operations, where the objective is to minimize a loss function L.
1) Given cluster labels post scoring, split the time series training data into three parts of Training-Validation-Test using stratified sampling on cluster labels;
2) Run candidate models F₁, F₂, F₃, F₄, and F₅ on Training data;
3) Calculate the accuracy measures A₁, A₂, A₃, A₄, A₅ on Validation, considering the Loss Function L;
4) Map the best candidate model for each item;
5) Find frequency distribution of best model selected across items for each cluster;
6) Map each cluster to the model with highest observed frequency;
7) Predict items in Test data using mapped best model for its respective cluster.

In one example, via the machine learning classification model, 100 training time series may be predicted and assigned with 5 possible shape labels, such as L1, L2, L3, L4, and L5. Four forecasting models may further be used to predict future values represented as F₁, F₂, F₃, and F₄. The purpose of the forecasting module 116 may be configured to predict future values and minimize forecasting errors.

Table 1 below illustrates a process of finding best forecasting model for each shape label. For any new time series of training data, the shape label assigned to each time series of training data may be identified first. Further, the training data may be divided into training samples and validation samples (e.g., test samples). The average forecast error may then be calculated for each shape label using each of the four forecasting models. Any error metric may be used to calculate an average forecasting error, such as like Maximum Absolute Percentage Error (MAPE) value, Symmetric Mean Absolute Percentage Error (SMAPE) value, etc.). Thus, the best forecasting model for a particular shape label of the training series is selected to be a model that can generate a lowest average forecasting error. The forecasting module 116 may be configured to choose a forecasting model for a particular shape label based on the lowest average forecast error. As illustrated in Table 1, the forecasting model F3 may be selected as the best forecasting model for the shape label L1 associated with a cluster of items. Similarly, the same process may be applied by the forecasting module 116 to obtain the best forecasting model for each shape label associated with a cluster of items.

TABLE 1
Average Forecast Error Table

| Shape Labels | F1 | F2 | F3 | F4 | Best Forecasting Model |
|---|---|---|---|---|---|
| L1 | 0.3 | 0.4 | 0.2 | 0.5 | F3 |
| L2 | 0.8 | 0.98 | 0.85 | 0.87 | F1 |
| L3 | 0.1 | 0.1 | 0.2 | 0.05 | F4 |
| L4 | 0.7 | 0.4 | 0.8 | 0.1 | F4 |
| L5 | 0.33 | 0.65 | 0.21 | 0.45 | F3 |

Item similarity module 118

By referring to FIG. 2, the methodology for identifying item similarity to each shape label is illustrated in the operations of 232-240 in the system workflow 200.

The data stored in the second database 104-3 with shape labels may be used as an input to the item similarity module 118.

At 232, the item similarity module 118 may select a reference item, using historical sales data from the POS database and the second datasets with shape labels.

At 234, the shape and effect features stored in the second datasets with shape labels in the second database 104-3 may be used as an input to the item similarity module 118.

At 236, the system may select each of four similar item search models or methods to apply on the second datasets with shape labels. The four similar item search models may include a full feature search, a reduced feature search, a model based search, and a fast combined search.

At 238, the system may apply multiple search models respectively on shape and effect features of the reference item in the second datasets to obtain a plurality of the similarity values. The search models may include a full feature search, a reduced feature search, a model based search, and a fast combined search.

At 240, the item similarity module 118 may be configured to efficiently identify a group of top K similar items for the reference item with a decreasing order of the plurality of the similarity values.

In some embodiments, the item similarity module 118 may provide four novel search algorithms to identify the item similarity.
1) Full feature search (FFS): Pairwise distance is calculated using all the item features stored in the second shape and effect datasets with shape labels. Euclidean distance is used as default distance measure. Alternative solution is to use cosine distance.
2) Reduced feature search (RFS): A dimension reduction is performed via Principal Component Analysis or Auto encoders before computing pairwise distances.
3) Model based search (MS): The pairwise distances are calculated using the output class probabilities of Machine Learning (ML) model in the SCBC System.
4) Fast combined search (FCS): This computationally efficient algorithm speeds up the search system by comparing pairwise distances for items having the same shape label.

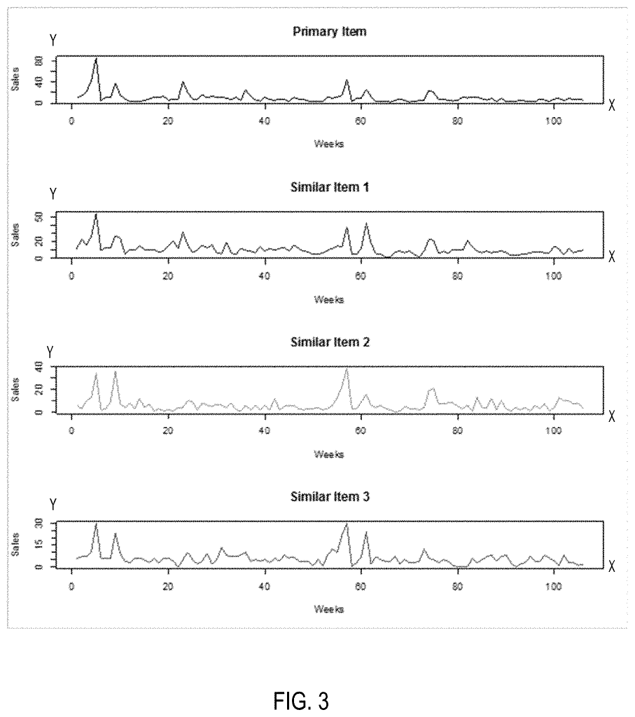

FIG. 3 is a diagram illustrating identified similar items in accordance with some embodiments. FIG. 3 shows time-series data including a primary item and 3 similar items. The x-axis represents a time variable in week within a range of a two-year period. The y-axis represents a sales value of the item at a particular week along a two-year time period. Y-axis can represent actual sales or normalized sale values. The primary item has 3 similar items, such as similar item 1, similar item 2, and similar item 3. Each similar item includes two-year time-series weekly sales. Two time-series datasets might be considered to be similar if they rise and fall simultaneously. The primary item and 3 similar items may share the same shape label. In some embodiments, correlation can be used to measure similarity between time-series datasets. The time series sales data may be normalized so as to compare sales between different items on the same scale.

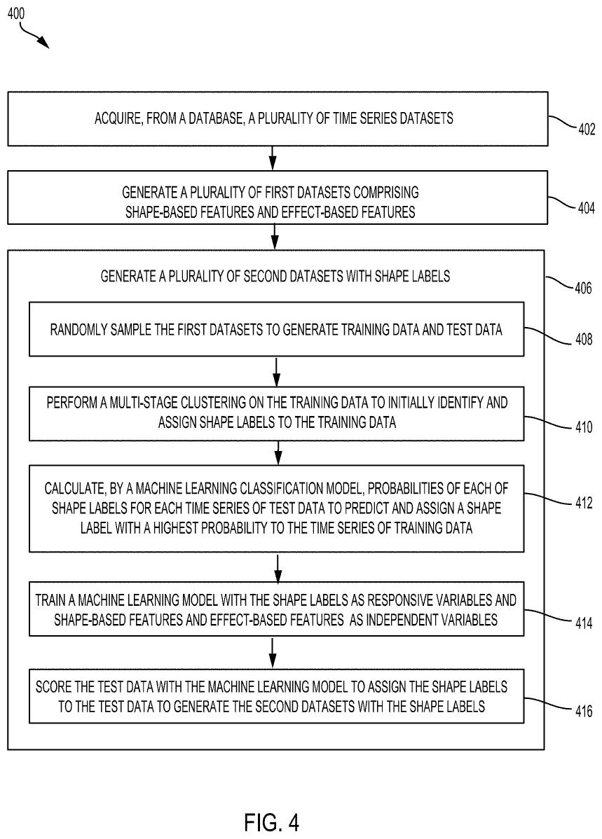

FIG. 4 is a flowchart diagram illustrating an example process for implementing a shape characteristics based classification in accordance with some embodiments.

The process 400 may be implemented in the above described systems or other application areas for data processing and analysis. Steps may be omitted or combined depending on the operations being performed. The method for implementing a shape characteristics based classification may be widely used for processing any type of time series data if the time series data associated with a plurality of items can be retrieved or acquired during a given period.

At 402, a plurality of time series datasets may be acquired or retrieved from a database. The time series datasets may be time series historical datasets during a given period of time, such as weeks, months, or years. Each of time series datasets may include a plurality of data points arranged within the given period of time.

At 404, based on date labels in the plurality of time series datasets, a plurality of first datasets may be generated with shape-based features and effect-based features. For example, the system may determine whether a date label is present in each time series dataset. In response to determining that the date label is present in each the time series dataset, the system may generate a first dataset with shape-based features and effect-based features for each item. In response to determining that the date label is not present in the time series dataset, the system may generate the first dataset with shape-based features for the item.

At 406, a plurality of second datasets may be generated by adding shape labels to the plurality of first datasets. The plurality of second datasets can be classified into clusters and each cluster may share a shape label. A shape label may be assigned to the time serial dataset as a number to indicate a particular underlying shape of a temporal variable of interest associated with the time serial dataset. The process of generating the plurality of the second datasets may further include the following operations.

At 408, the system may randomly sample a plurality of the first datasets to generate training data and test data.

At 410, a multi-stage clustering can be performed on the training data to initially identify and assign shape labels to the training data. The training data can be classified into clusters and each cluster may share a shape label. In the first stage of clustering, clustering is applied on repeated bootstrapped samples drawn from the training data. In the second stage of clustering, the items consistently remaining in a same cluster are identified.

At 412, a machine learning classification model may be developed to calculate probabilities of each of shape labels for each time series of training data. For example, the training data may have 5 types of shape labels. The 5 types of shape labels may be represented as L1, L2, L3, L4 and L5.

The training data contains features and a target variable containing the corresponding shape labels. The machine learning classification model is applied on a plurality of time series of training data to predict a shape label for each of the time series of training data. This a machine learning classification model predicts the class probabilities, i.e., the probability of any time series belonging to each of the 5 shape labels. The machine learning classification model may be used to predict and assign shape labels for every new time series by selecting a shape label with the highest probability.

At 414, a machine learning classification model may be built and trained with the shape labels as responsive variables. The machine learning classification model may be built with shape-based features and effect-based features as independent variables.

At 416, the machine learning classification model may be used to score the test data with the predicted shape labels to the test data and assign the shape label to the test data to generate the second datasets with the shape labels. A second datasets with shape labels may be generated with a shape label assigned to each item in the first datasets. Table 2 below illustrates the results of the scoring process 222 of predicting shape labels for 5 time series of test data 214. The machine learning classification model is configured to calculate the class probabilities, i.e., the probability of the time series belonging to each of the 5 shape labels. Table 2 shows a set of calculated probabilities of each of the 5 shape labels for each time series of test data. As illustrated in Table 2, the time series 1 of test data has the highest probability of 0.5 with shape label “L2”. Thus, the machine learning classification model may predict and assign the shape label “L2” to the time series 1. As shown in Table 2, each of time series may be predicted and assigned with a corresponding predicted shape label.

TABLE 2
Test Data

| | L1 | L2 | L3 | L4 | L5 | Predicted label |
|---|---|---|---|---|---|---|
| Series 1 | 0.3 | 0.5 | 0.1 | 0.05 | 0.05 | L2 |
| Series 2 | 0.15 | 0.05 | 0.7 | 0.08 | 0.02 | L3 |
| Series 3 | 0.9 | 0 | 0 | 0.1 | 0 | L1 |
| Series 4 | 0.1 | 0.1 | 0.1 | 0.1 | 0.6 | L5 |
| Series 5 | 0.1 | 0.23 | 0.58 | 0.08 | 0 | L3 |

By applying the scoring process 222 on a plurality of clusters of items, each item in a cluster may be assigned with a shape label. For examples, there may be hundreds or thousands of items in one cluster, all items in a cluster may share the same shape label. Thus, each time series of test data (e.g., the data of the second datasets) associated with a particular item may be assigned with a unique shape label.

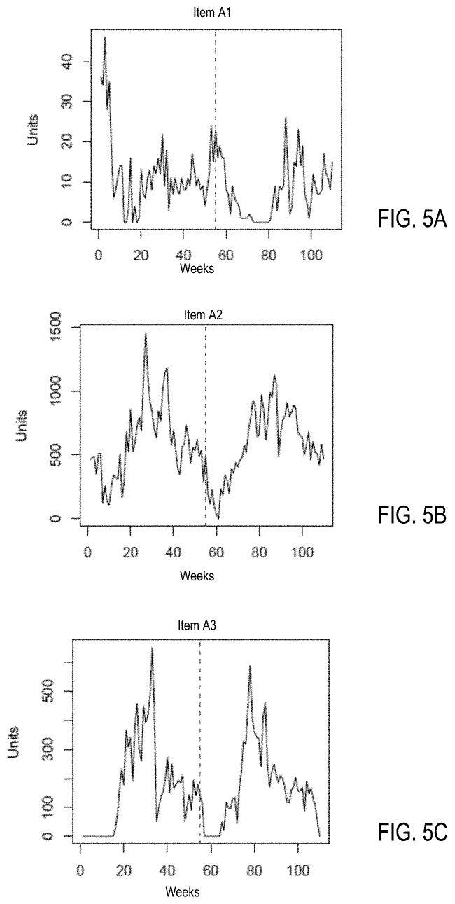

FIGS. 5A, 5B, and 5C are diagrams illustrating examples of a cluster of items with time series sharing a shape label with a curve shape in accordance with one embodiment. FIGS. 5A, 5B, and 5C show a cluster of items A1, A2, and A3 with time series sharing a shape label with a curve shape (e.g., shape label L1). There may be time series of hundreds or thousands of items in the cluster to share the curve shape with the same shape label L1.

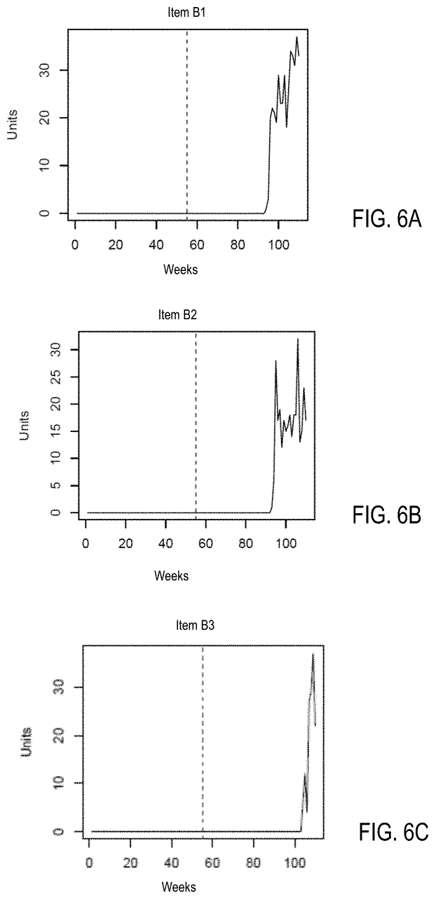

FIGS. 6A, 6B, and 6C are diagrams illustrating examples of a cluster of new items with time series sharing a shape label in accordance with one embodiment. FIGS. 6A, 6B, and 6C show a cluster of items B1, B2, and B3 with time series sharing a shape label with a new item shape (e.g., shape label L2). There may be time series of hundreds or thousands of items in the cluster to share the new item shape with the same shape label L2.

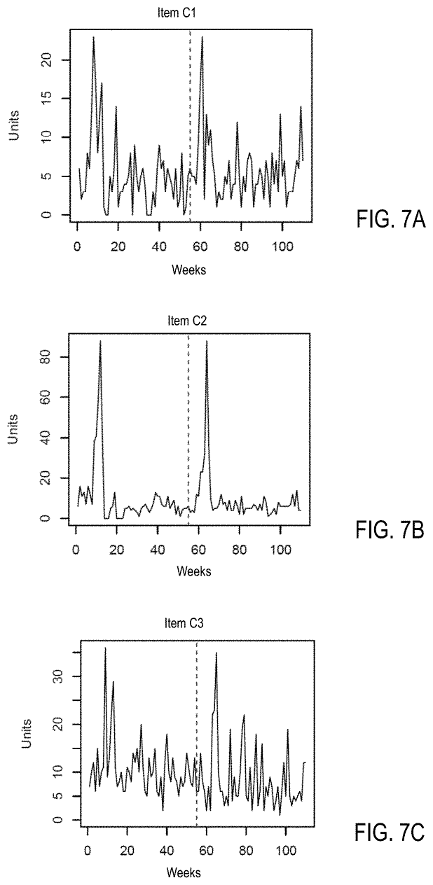

FIGS. 7A, 7B, and 7C are diagrams illustrating examples of a cluster of items with time series sharing a shape label with a spike shape in accordance with one embodiment. FIGS. 7A, 7B, and 7C show a cluster of items C1, C2, and C3 with time series sharing a shape label with a spike shape (e.g., shape label L3). There may be time series of hundreds or thousands of items in the cluster to share the spike shape with the same shape label L3.

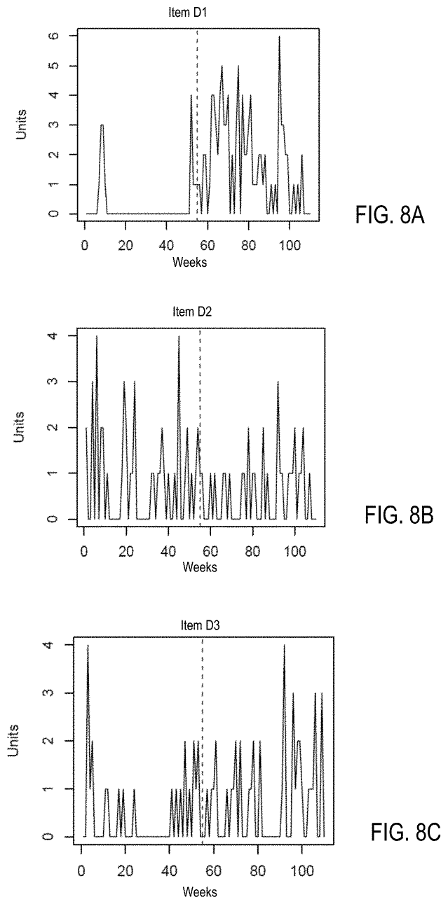

FIGS. 8A, 8B, and 8C are diagrams illustrating examples of a cluster of new items with time series sharing a shape label with a scattered shape in accordance with one embodiment. FIGS. 8A, 8B, and 8C show a cluster of items D1, D2, and D3 with time series sharing a shape label with a scattered shape (e.g., shape label L4). There may be time series of hundreds or thousands of items in the cluster to share the scattered shape with the same shape label L4.

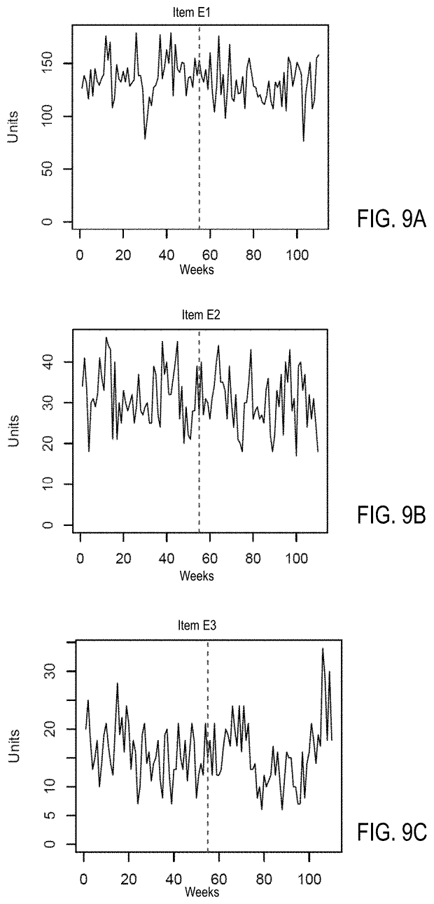

FIGS. 9A, 9B, and 9C are diagrams illustrating examples of a cluster of items with time series sharing a shape label with a steady changing shape in accordance with one embodiment. FIGS. 9A, 9B, and 9C show a cluster of items E1, E2, and E3 with time series sharing a shape label with a steady changing shape (e.g., shape label L5). There may be time series of hundreds or thousands of items in the cluster to share the steady changing shape with the same shape label L5. All data of the second datasets may be predicted and assigned via the described scoring process 222 with corresponding shape labels and stored in a second database 104-3.

Referring to FIG. 2, the data of the second datasets with shape labels stored in a second database 104-3 may be used as an input to the forecasting module 116 for find the best forecasting model for each item. Additionally, the data of the second datasets with shape labels stored in a second database 104-3 may be used as an input to the item similarity module 118 for efficiently identifying top K similar item for a reference item.

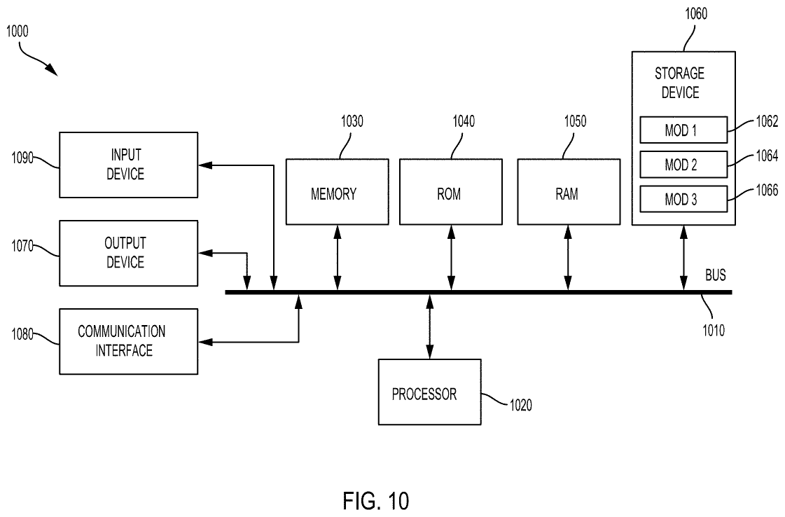

FIG. 10 illustrates an example computer system 1000 which can be used to implement embodiments as disclosed herein. With reference to FIG. 10, an example system 1000 can include a processing unit (CPU or processor) 1020 and a system bus 1010 that couples various system components including the system memory 1030 such as read only memory (ROM) 1040 and random access memory (RAM) 1050 to the processor 1020. The system 1000 can include a cache of high speed memory connected directly with, in close proximity to, or integrated as part of the processor 1020. The system 1000 copies data from the memory 1030 and/or the storage device 1060 to the cache for quick access by the processor 1020. In this way, the cache provides a performance boost that avoids processor 1020 delays while waiting for data. These and other modules can control or be configured to control the processor 1020 to perform various actions. Other system memory 1030 may be available for use as well. The memory 1030 can include multiple different types of memory with different performance characteristics. It can be appreciated that the disclosure may operate on a computing device 1000 with more than one processor 1020 or on a group or cluster of computing devices networked together to provide greater processing capability. The processor 1020 can include any general purpose processor and a hardware module or software module, such as module 1 1062, module 2 1064, and module 3 1066 stored in storage device 1060, configured to control the processor 1020 as well as a special-purpose processor where software instructions are incorporated into the actual processor design. The processor 1020 may essentially be a completely self-contained computing system, containing multiple cores or processors, a bus, memory controller, cache, etc. A multi-core processor may be symmetric or asymmetric.

The system bus 1010 may be any of several types of bus structures including a memory bus or memory controller, a peripheral bus, and a local bus using any of a variety of bus architectures. A basic input/output (BIOS) stored in ROM 1040 or the like, may provide the basic routine that helps to transfer information between elements within the computing device 1000, such as during start-up. The computing device 1000 further includes storage devices 1060 such as a hard disk drive, a magnetic disk drive, an optical disk drive, tape drive or the like. The storage device 1060 can include software modules 1062, 1064, 1066 for controlling the processor 1020. Other hardware or software modules are contemplated. The storage device 1060 is connected to the system bus 1010 by a drive interface. The drives and the associated computer-readable storage media provide non-volatile storage of computer-readable instructions, data structures, program modules and other data for the computing device 1000. In one aspect, a hardware module that performs a particular function includes the software component stored in a tangible computer-readable storage medium in connection with the necessary hardware components, such as the processor 1020, bus 1010, output device 1070, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 1000 is a small, handheld computing device, a desktop computer, or a computer server.

Although the exemplary embodiment described herein employs the hard disk 1060, other types of computer-readable media which can store data that are accessible by a computer, such as magnetic cassettes, flash memory cards, digital versatile disks, cartridges, random access memories (RAMs) 1050, and read only memory (ROM) 1040, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1000, an input device 1090 represents any number of input mechanisms, such as a microphone for speech, a touch-sensitive screen for gesture or graphical input, keyboard, mouse, motion input, speech and so forth. An output device 1070 can also be one or more of a number of output mechanisms known to those of skill in the art. In some instances, multimodal systems enable a user to provide multiple types of input to communicate with the computing device 1000. The communications interface 1080 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

What is claimed is:

1. An item forecasting system, comprising:
a processor on a computing device; and
a computer-readable non-transitory storage medium memory storing computer executable instructions, the instructions operable to cause the processor to execute:
a shape characteristics based classification module programmed to:
acquire a plurality of time series datasets associated with a plurality of items,
generate, based on date labels associated with the plurality of time series datasets, a plurality of first datasets comprising shape-based features and effect-based features, and
generate, based on the plurality of the first datasets, a plurality of second datasets with shape labels, wherein the items in the second datasets are classified into clusters and wherein each cluster shares a shape label; and
a forecasting module programmed to:
run a plurality of candidate forecasting models on each shape label associated with each cluster in the second datasets to obtain an average forecast error for each shape label,
select a best forecasting model with a lowest average forecast error for each shape label, and
assign the best forecasting model to each item in the cluster sharing the shape label for an item prediction.

2. The system of claim 1, wherein the shape-based features are associated with temporal variables including sales and price, and wherein the effect-based features are associated with temporal variables including holiday data and marketing promotion data of the plurality of items.

3. The system of claim 1, wherein the shape labels are assigned to the items as a series of numbers; and wherein each shape label indicates a particular underlying shape of a temporal variable of interest associated with a cluster of items in the second datasets.

4. The system of claim 1, wherein the shape characteristics based classification module is further configured to:
determine whether a date label is present in each time series dataset;
in response to determining that the date label is present in each of the time series dataset, generate a first dataset with shape-based features and effect-based features for each item; and
in response to determining that the date label is not present in the time series dataset, generate the first dataset with shape-based features for the item.

5. The system of claim 1, wherein the shape characteristics based classification module is further configured to:
randomly sample the first datasets to generate training data and test data;
perform a multi-stage clustering on the training data to initially identify and assign shape labels to the training data;
calculate, by a machine learning classification model, probabilities of each of shape labels for each time series of test data to predict and assign a shape label with a highest probability to a time series of training data;
train the machine learning classification model with the plurality of shape labels as responsive variables and shape-based features and effect-based features from the first datasets as independent variables; and
score the test data with the machine learning classification model to assign a shape label to the test data to generate the second datasets with the shape labels.

6. The system of claim 5, wherein performing the multi-stage clustering on the training data further comprises:
performing the clustering on repeated bootstrapped samples drawn from the training data;
identifying the items in the training data that form a homogeneous cluster;
removing the items with inconsistent shape labels from the training data; and
generating clusters represented by key characteristics of items.

7. A system for identifying item similarity, comprising:
a processor on a computing device; and
a computer-readable non-transitory storage medium memory storing computer executable instructions, the instructions operable to cause the processor to execute:
a shape characteristics based classification module programmed to:
acquire a plurality of time series datasets associated with a plurality of items,
generate, based on date labels associated with the plurality of time series datasets, a plurality of first datasets comprising shape-based features and effect-based features, and
generate, based on the plurality of the first datasets, a plurality of second datasets with shape labels, wherein the items in the second datasets are classified into clusters and wherein each cluster shares a shape label; and
an item similarity module programmed to:
select a reference item for each cluster of items,
apply a plurality of search models respectively on shape-based and effect-based features of the reference item in the second datasets to obtain a plurality of similarity values, the plurality of search models comprising a full feature search, a reduced feature search, a model based search, and a fast combined search, and
identify top K similar items for the reference item with a decreasing order of the plurality of the similarity values.

8. The system of claim 7, wherein the shape-based features of the item are associated with temporal variables including sales and price, and wherein the effect-based features of the item are associated with temporal variables including holiday data and marketing promotion data of the item.

9. The system of claim 7, wherein the shape labels are assigned to the items as a series of numbers; and wherein each shape label indicates a particular underlying shape of a temporal variable of interest associated with a cluster of items in the second datasets.

10. The system of claim 7, wherein the shape characteristics based classification module is further configured to:
determine whether a date label is present in each time series dataset;
in response to determining that the date label is present in each of the time series dataset, generate a first dataset with shape-based features and effect-based features for each item; and
in response to determining that the date label is not present in the time series dataset, generate the first dataset with shape-based features for the item.

11. The system of claim 7, wherein the shape characteristics based classification module is further configured to:
randomly sample the first datasets to generate training data and test data;
perform a multi-stage clustering on the training data to initially identify and assign shape labels to the training data;
calculate, by a machine learning classification model, probabilities of each of shape labels for each time series of test data to predict and assign a shape label with a highest probability to a time series of training data;
train the machine learning classification model with the plurality of shape labels as responsive variables and shape-based features and effect-based features from the first datasets as independent variables; and
score the test data with the machine learning classification model to assign a shape label to the test data to generate the second datasets with the shape labels.

12. The system of claim 11, wherein performing the multi-stage clustering on the training data further comprises:
performing the clustering on repeated bootstrapped samples drawn from the training data;
identifying the items in the training data that form a homogeneous cluster;
removing the items with inconsistent shape labels from the training data; and
generating clusters represented by key characteristics of items.

13. A non-transitory computer-readable storage medium having executed instructions stored which, when executed by a processor on a computing device, cause the processor to perform operations comprising:
acquiring a plurality of time series datasets;
generating, based on date labels associated with plurality of time series datasets, a plurality of first datasets comprising shape-based features and effect-based features; and
generating, based on the plurality of the first datasets, a plurality of second datasets with shape labels, wherein the plurality of second datasets are classified into clusters and wherein each cluster shares a shape label, wherein generating the plurality of the second datasets comprising:
randomly sampling the first datasets to generate training data and test data;
performing a multi-stage clustering on the training data to initially identify and assign shape labels to the training data;
calculate, by a machine learning classification model, probabilities of each of shape labels for each time series of training data to predict and assign a shape label with a highest probability to a cluster of test data;
train the machine learning classification model with the plurality of shape labels as responsive variables and shape-based features and effect-based features from the first datasets as independent variables; and
score the test data with the machine learning classification model to assign a shape label to the test data to generate the second datasets with the shape labels.

14. The non-transitory computer-readable storage medium of claim 13, wherein the shape labels are a series of numbers and wherein each shape label indicates a particular underlying shape of a temporal variable of interest associated with each of the plurality of first datasets.

15. The non-transitory computer-readable storage medium of claim 13, wherein the shape-based features are associated with temporal variables related to sales and prices of a plurality of items.

16. The non-transitory computer-readable storage medium of claim 13, wherein the effect-based features of the first datasets are associated with temporal variables related to holiday data and marketing promotion data of a plurality of items.

17. The non-transitory computer-readable storage medium of claim 13, wherein the operations further comprise:
determining whether a date label is present in each time series dataset;
in response to determining that the date label is present in each of the time series dataset, generating a first dataset with shape-based features and effect-based features for each item; and
in response to determining that the date label is not present in the time series dataset, generating the first dataset with shape-based features for the item.

18. The non-transitory computer-readable storage medium of claim 13, wherein the operations further comprise:
performing the clustering on repeated bootstrapped samples drawn from the training data;
identifying items in the training data that form a homogeneous cluster;
removing the items with inconsistent shape labels from the training data; and
generating clusters represented by key characteristics of items.

19. The non-transitory computer-readable storage medium of claim 13, wherein the processor is configured to execute a forecasting module to perform operations comprising:
running, based on the shape label, a plurality of candidate forecasting models on each cluster in the second datasets to obtain an average forecast error for each cluster;
selecting a best forecasting model with a lowest average forecast error for each shape label; and
assigning the best forecasting model to the shape label associated with each item in the cluster for an item prediction.

20. The non-transitory computer-readable storage medium of claim 13, wherein the processor is configured to execute an item similarity module to perform operations comprising:
selecting a reference item for each cluster of items;
applying a plurality of search models respectively on shape-based and effect-based features of the reference item in the second datasets to obtain a plurality of similarity values; and
identifying top K similar items for the reference item with a decreasing order of the plurality of the similarity values,
wherein the plurality of search models comprising a full feature search, a reduced feature search, a model based search, and a fast combined search.
